(19) United States
(12) Patent Application Publication
(10) Pub. No.: US 2018/0209456 A1
(43) Pub. Date: Jul. 26, 2018

(54) HELICAL-DRIVE CAPTIVE PANEL FASTENER FOR INSERTING, EXTRACTING, AND FLUSH-MOUNTING PANELS IN MUTUAL CONTACTING ENGAGEMENT

(71) Applicant: Kevin M. Antosh, Townsend, MA (US)

(72) Inventor: Kevin M. Antosh, Townsend, MA (US)

(21) Appl. No.: 15/843,027

(22) Filed: Dec. 15, 2017

Related U.S. Application Data
(63) Continuation of application No. PCT/US2016/037508, filed on Jun. 15, 2016.
(60) Provisional application No. 62/175,506, filed on Jun. 15, 2015.

(51) Int. Cl. F16B 5/02; H01R 13/621; B25B 27/14

(52) U.S. Cl. CPC F16B 5/0208; B25B 27/14; H01R 13/621

(57) ABSTRACT

A fastener assembly for bringing into contacting engagement a module-mounting plate with a retaining-sleeve aperture and a module-supporting plate with a receptacle aperture includes first and second sub-assemblies. The first sub-assembly includes a shaft-retaining sleeve within which there is retained for rotation relative to the shaft-retaining sleeve a drive shaft having drive-shaft distal and proximate portions, the distal portion having defined thereabout a helical grove. The shaft-retaining sleeve is press fit within the retaining-sleeve aperture such that the drive-shaft proximal and distal portions protrude from opposite sides of the module-mounting plate. Press fit into the receptacle aperture is a shaft receptacle defining a through-bore into which protrudes a drive pin configured for selective mechanical registration with the helical groove such that rotation of the drive shaft in a first direction draws the plates into flush contacting engagement, while rotation in a second direction opposite the first direction separates the plates.

### CROSS-REFERENCE TO RELATED APPLICATION/PRIORITY CLAIMS

The present application is a continuation of International Application Serial No. PCT/US2016/037508 filed Jun. 15, 2016 pursuant to the Patent Cooperation Treaty, and under the title “HELICAL-DRIVE CAPTIVE-PANEL FASTENER ASSEMBLY.” Application PCT/US2016/037508 claimed priority benefits in U.S. Provisional Application No. 62/175,506 filed Jun. 15, 2015 under the title “HELICAL-DRIVE CAPTIVE-PANEL FASTENER ASSEMBLY.”

The present application claims the benefit of the filing date of Provisional Application Ser. No. 62/175,506, as well as the filing date of PCT Application No. PCT/US2016/037508, based on the priority chain outlined above. Moreover, the entireties of the disclosures, including the drawings, of both previous applications in the aforesaid priority chain are incorporated herein by reference as if set forth fully in the present application.

### BACKGROUND

Embodiments of the present invention relate generally to the insertion and extraction of a field replaceable unit (FRU) and, in more particular instances, the seating and unseating of an electrical connection into a mating connector or backplane. Illustrative such electrical connections are the familiar “pin-and-socket” and “tab-and-socket” connectors.

Modularity has come to play a major role in the way many different types of systems employing circuit boards, for example, are architected today. The use of modular devices has increased significantly over the years and continues to expand into other markets as it allows greater flexibility to build and maintain systems. In some industries, such as telephone and computer networking, modularity has become a requirement upon which product approvals are contingent. Whether in computing, networking, marine, medical, military or aerospace applications, there is a need for addressing modular applications without the use of tools in a way that would be accepted within the industry.

Properly inserting a printed circuit board into an electrical device can be a tedious and difficult task. Each individual pin or tab, for example, requires a certain amount of force to properly seat it into its corresponding socket. The total force required to seat the printed circuit board or other module includes the cumulative sum of the forces required to seat each individual pin or tab. Thus, as the number of pins or tabs increase, the force required to seat the printed circuit board likewise increases.

It is common on a field replaceable unit (FRU), or module, to include one or more rotating levers used to overcome the insertion and extraction forces of mating electrical connections. To provide sufficient extraction force to dislodge a FRU, the rotating levers include cams which, when the lever is rotated in a predetermined extracting direction, cause the incremental displacement of the FRU toward the extraction direction. It is also common to include one or more captive threaded fasteners on the same FRU, which are used primarily to secure the FRU and prevent an accidental disengagement leading to module and/or system shutdown. For example, a system will not meet NEBS (Network Equipment-Building System) earthquake testing standards if a module becomes disengaged during the testing. Therefore, the captive threaded fasteners are used in conjunction with the mechanical levers to assure this does not happen.

The challenge of using these conventional mechanical components has increased with growing module densities and the need to package as much circuitry as possible into confined spaces for increased product functionality. This continues to play a role when defining a system, and requires decisions around what is needed to install, secure, and extract a modular device in a space-saving effort. As electrical-connector pin count increases, the insertion and extraction forces increase, thereby requiring a longer lever to insert and extract the module. It is desirable to reduce the amount of panel space required to address the mechanical needs in order to maximize the space available for other possibilities, such as increased electrical-port density.

Seating a panel flush against a fixed housing (cabinet or chassis) has become a standard industry-design practice. Flush seating provides a positive stop during module insertion and facilitates the simplest mechanical construction required, thereby reducing cost on both sides of the interface. One early attempt at eliminating some of the aforementioned mechanical aids such as levers and threaded fasteners (e.g., alignment screws) is represented by U.S. Pat. No. 6,904,655 granted to inventors Lima et al., and assigned to Juniper Networks, Inc. (hereinafter, “the '655 patent,” “the Lima patent,” “the Juniper patent,” or similar).

Although the module-seating apparatus described in the '655 patent presumably obviates the need for levers and threaded fasteners in removing and installing of a module—referred to by Lima as “removable component”—itself into a module-receiving slot defined in a housing or chassis, in so doing, it introduced its own issues. More specifically, the Lima device includes a shaft with a helical groove to be carried by the module and a receptacle assembly carried by the chassis or “fixed component” and including a pin configured for mechanical registration with the helical groove. The shaft is mounted for rotation with respect to the module by a housing which is, in turn, mounted to the inner side (opposite the installer/user) of a securing plate depending from the module. The shaft protrudes through the housing, the securing plate, and rearwardly of the securing plate where it terminates in a handle for facilitating shaft rotation by a user. The housing by which the shaft is mounted to the module itself consumes space and is itself mounted to the securing plate of the module by threaded fasteners, such as screws. To the rear of the panel to which the module is to be secured is mounted a “receptacle assembly,” which, like the housing fastened to the securing plate of the module, is a blocky, space-consuming fixture mounted to the chassis panel by threaded fasteners, such as screws. The “receptacle assembly” includes the throughbore through which the helical shaft carried by the module is received, as well as the pin configured for registration with the helical groove formed along the shaft.

Accordingly, a need still exists for industry-acceptable fastening apparatus having the ability to accommodate and facilitate module insertion and extraction functionality by hand leveraging two flush-mounted panels or “plates,” while reducing the need for additional hardware, components and support structures previously required to support these operations.

### SUMMARY

Embodiments of the present invention are configured as helix-drive captive-panel fasteners for generally facilitating the selective capture and retention of a module within a chassis (alternatively, “cabinet” or “housing”). Typically, such a chassis includes a main frame or body with a front panel defining a plurality of module slots, each of which module slots is configured for receipt and removable retention of a module. Although not so limited in utility or scope, except to the extent explicitly indicated in particular claims, the chassis may be a circuit-board chassis that constitutes a mechanical portion of an overall circuit-board system such as, by way of non-limiting example, a computer system or network router. Relatedly, the removable modules that are selectively insertable into, and retainable within, the various module slots may be or include printed circuit boards, for example.

Irrespective of the nature of either the chassis or each module that is selectively retainable by the chassis, an overall feature of the environment in which embodiments of the invention will find applicability is such that the chassis generally includes a forward-facing front panel into which modules are inserted for selective retention. Each module, in turn, includes at least one “module-mounting plate” or “module-mounting tab” that is held flush—also referred to as “flush-mounted”—against a front-panel portion when the module is retained within the chassis. The mutual contacting engagement between each of the at least one module-mounting tabs and the front-panel portion against which it is retained flush is achieved and maintained by a helix-drive captive-panel fastener assembly which, for purposes of brevity, may be referred to simply as a fastener assembly. Moreover, without departing from the overall conceptual scope, and for purposes of consistency in the use of language, the chassis to which a module is to be mounted will be said to include, or have depending therefrom, a “module-support plate,” while the module to be mounted will be said to include, or have depending therefrom, a “module-mounting plate” configured for contacting engagement (“flush-mounting”) with the module-support plate when the module is mounted on or within the chassis. In various embodiments, the module-mounting and module-support plates are formed of “sheet stock” metal or, simply, sheet metal of any of various gauges.

Illustratively embodied, a hand-operated (i.e., requiring no tools) fastener assembly configured for selectively retaining a module-mounting plate of a module to be mounted within a module chassis flush against a module-supporting plate carried by the module chassis includes first and second sub-assemblies configured for direct mutual mechanical engagement (i.e., cooperative mating). The first sub-assembly includes a draft shaft extending lengthwise along a longitudinal shaft axis between opposed shaft proximal and distal ends representing, respectively, the extreme rear and forward ends of the drive shaft. A drive-shaft proximal portion extends lengthwise and forwardly of the proximal end toward the distal end, while a drive-shaft distal portion extends lengthwise and rearwardly of the distal end toward the proximal end. Moreover, a shaft intermediate portion is situated along the lengthwise extent of the drive shaft such that at least a portion of the drive-shaft proximal portion extends rearwardly of the intermediate portion and at least a portion of the drive-shaft distal portion extends forwardly of the intermediate portion. Defined peripherally about and axially along the distal portion is a helical groove.

The first sub-assembly additionally includes a shaft-retaining sleeve having defined therethrough a cylindrical through-channel. The drive shaft is supported within the through-channel, about the shaft intermediate portion, for rotation relative to the shaft-retaining sleeve. By supporting the drive shaft within the shaft-retaining sleeve about the shaft intermediate portion, the drive-shaft proximal and distal portions axially protrude to the outside of the shaft-retaining sleeve, on opposite sides thereof. For the purpose of establishing consistency in directional convention, the protrusion from the shaft-retaining sleeve of the drive-shaft proximal portion is regarded as “rearward,” while the protrusion from the shaft-retaining sleeve of the drive-shaft distal portion is regarded as “forward.” Moreover, at the same time the drive shaft is retained for free rotation, it is restrained for limited axial displacement between forwardmost and rearwardmost axial shaft positions relative to the shaft-retaining sleeve. The reason at least some embodiments allow for limited axial displacement of the drive shaft within the shaft-retaining sleeve is explained later in the summary and detailed description.

In various versions, the shaft-retaining sleeve is configured as a mechanical fitting that is “press fit” directly into a retaining-sleeve aperture defined through the module-mounting plate. Press fitting is not only a simple and efficient manufacturing method, it is an effective way of ensuring that the shaft-retaining sleeve is held captive against both axial and lineal displacement relative to the module-mounting plate.

The second sub-assembly includes a shaft receptacle having a cylindrical receptacle-interior wall defining a cylindrical through-bore and a through-bore axis about which the receptacle-interior wall extends. A drive pin protrudes inwardly from the receptacle-interior wall toward the through-bore axis. The module-supporting plate carried by the module chassis has defined therethrough a receptacle aperture within which the shaft receptacle is held captive against both axial and lineal displacement relative to the module-supporting plate. In various implementations, the shaft receptacle is held directly captive within the receptacle aperture of the module-supporting plate by a press fit.

Securely capturing the shaft-retaining sleeve “directly” within the module-mounting plate and the shaft receptacle directly within the module-supporting plate simplifies construction and substantially reduces the number of “intermediary” hardware components required to secure the drive shaft and the shaft receptacle to their respective plates relative to the device of the Lima patent, for example. While it is true that, in most instances, pressing fitting is a permanent securement means, it is fast, efficient, and reliable. For most applications, any limitations on the ability to reconfigure module mounting hardware that would normally require removal of same is outweighed by the substantial reduction in components associated with the fastener assembly.

The shaft receptacle and drive shaft are configured for selective mating engagement by the axial introduction and angular alignment of the shaft distal end into the through-bore of the shaft receptacle such that the drive pin enters the helical grove through a groove entrance. With the drive pin and helical groove mutually mechanically registered, the drive shaft can be further advanced into the through-bore by rotating the drive shaft in a rotational first direction. As the drive shaft advances into the through-bore, the drive pin advances within the helical groove from the groove entrance toward the shaft intermediate portion and the shaft proximal end. The maximum extent to which the drive pin can advance into the helical groove is defined by a groove terminus.

By extension, mechanical registration with the drive pin and rotation of the drive shaft in the rotational first direction causes the lineal advancement of the module-mounting plate toward and, eventually, into flush contacting engagement with the module-support plate. The “flush contacting engagement” of module-mounting plate with the module-support plate corresponds with the drive pin reaching the groove terminus. Conversely, by rotation of the drive shaft in a rotational second direction opposite that of the rotational first direction, the module-mounting and module-supporting plates can be separated from contacting engagement and, eventually, freeing of the module from the module chassis. In each of various alternative versions, the draft-shaft proximal portion carries a knob in order to facilitate the application to the drive shaft of torque sufficient in magnitude to axially advance and withdraw the drive shaft within the through-bore of the shaft receptacle.

In various embodiments, the groove terminus defines a detent which, when entered by the drive pin, permits the drive shaft to displace axially between the aforementioned forwardmost and rearwardmost axial shaft positions relative to the shaft-retaining sleeve. In embodiments including a detent, the drive shaft is normally biased toward the rearwardmost axial shaft position by a biasing member. Moreover, the detent is configured such that, as the drive pin approaches the groove terminus, the biasing member “loads” (e.g., compresses) by forcing limited forward axial displacement of the drive shaft and then, as the drive pin “falls into” to the detent, the biasing member “unloads” or “releases” energy stored during loading (e.g., compression). This action creates a tactile sensation perceptible to the operator. Rotation of the drive shaft in the opposite, rotational second direction overcomes the force exerted by the biasing member, thus causing the pin to exit the detent and travel along the helical groove forward toward the shaft distal end. In various embodiments, the biasing member is a coil spring helically disposed about the drive shaft, and internal—at least partially—to the shaft-retaining sleeve.

The helix-drive captive-panel fastener assembly provides a significant mechanical advantage over existing captive panel fastening technologies when the use of tools is not an option. The engagement of a drive pin with the helical groove at a single point of contact allows the pitch of the helical groove to be much greater than that possible using industry-standard threads. For example, one rotation of the knob grips and pulls the module-mounting plate into full insertion/engagement with the chassis slot and the module-support plate thereof. One rotation in the opposite direction unseats the device. In an illustrative version, a single revolution advances the module-mounting plate over 5/16 of an inch, seating it flush with the module-support plate. This amount of axial displacement as a function of shaft rotation simply cannot be achieved using threaded members, thereby rendering the combined features of the helix-drive captive-panel fastener assembly an attractive solution for tool-less module insertion and extraction.

Representative embodiments are more completely described and depicted in the following detailed description and the accompanying drawings.

### BRIEF DESCRIPTION OF THE DRAWINGS

FIG. 1 is an exploded perspective view of first and second sub-assemblies of a helix-drive captive-panel fastener assembly;

FIG. 2 is an exploded assembly view of the helix-drive captive-panel fastener assembly of FIG. 1 along with illustrative flush-mating panels (plates) to be fastened into contacting engagement by the fastener assembly;

FIG. 3 is a cross sectional view showing the fastener assembly of FIGS. 1 and 2 installed and fully engaged;

FIG. 4A shows a top view of a full-turn rotatable drive shaft mechanism;

FIG. 4B shows a side view (rotated 90-deg.) of the full-turn rotatable drive shaft mechanism of FIG. 4A;

FIG. 4C depicts a top elevation view of an illustrative ½-turn rotatable drive shaft mechanism;

FIG. 5A depicts both a top cross-sectional view (left side) and side elevation view (right side) of a fastener-assembly knob;

FIG. 5B provides a perspective view of an optional plastic knob including a metal insert; and

FIG. 6 shows perspective views of illustrative alternative knob configurations.

### DETAILED DESCRIPTION

The following description of variously embodied helix-drive captive-panel fastener assemblies is demonstrative in nature and is not intended to limit the invention or its application of uses. Accordingly, the various implementations, aspects, versions and embodiments described in the summary and detailed description are in the nature of non-limiting examples falling within the scope of the appended claims and do not serve to define the maximum scope of the claims.

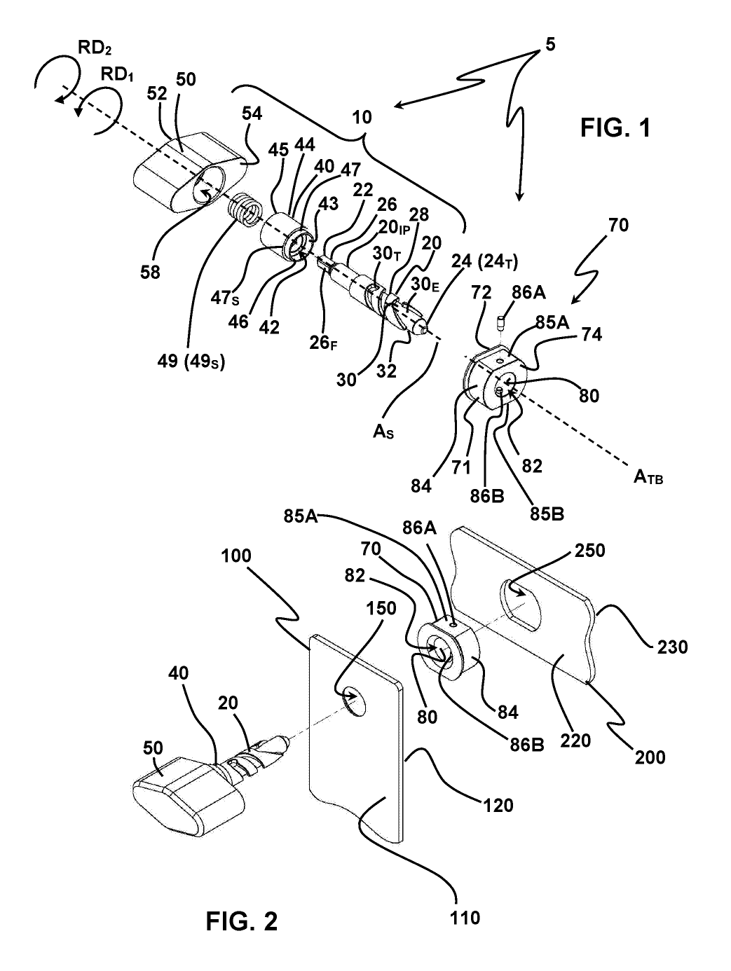

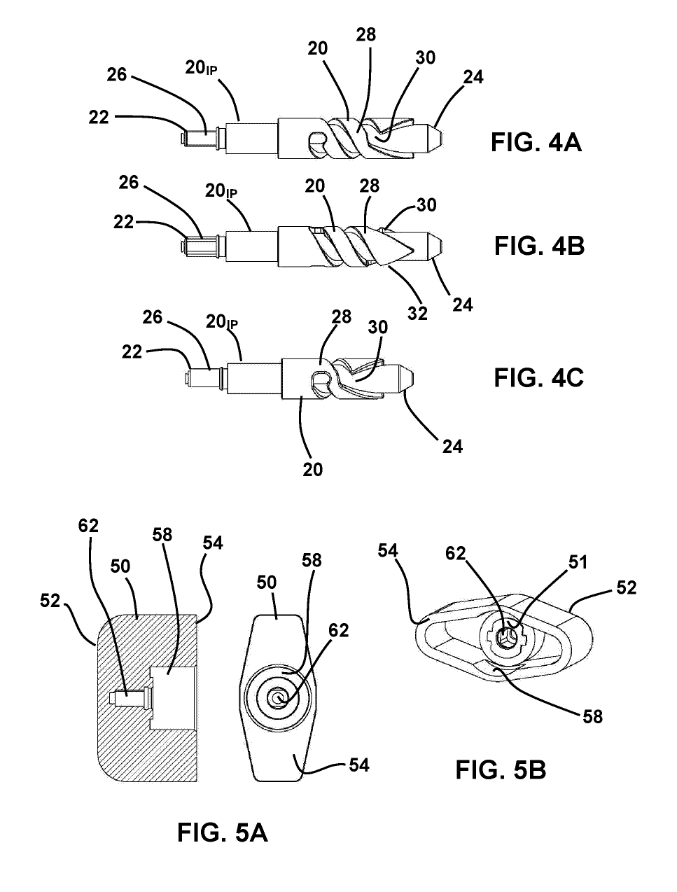

Shown in FIGS. 1, 2, 3, 4A, 4B, 4C, 5A, 5B and 6 are variously configured helix-drive captive-panel fastener assemblies 5 and illustrative components thereof. For purposes of brevity, each helix-drive captive-panel fastener assembly 5 may be referred to alternatively as simply a fastener assembly 5. Each fastener assembly 5 includes first and second sub-assemblies 10 and 70 configured for mutual cooperative mating.

The first sub-assembly 10 is a drive mechanism including a drive shaft 20 and a cylindrical shaft-retaining sleeve 40 defining a sleeve through-channel 42 through which the drive shaft 20 extends. The drive shaft 20 extends lengthwise along a longitudinal shaft axis A_{S} between a shaft proximal end 22 representing the extreme rear end of the drive shaft 20 and a shaft distal end 24 representing the extreme forward end of the drive shaft 20. In at least some embodiments, the shaft distal end 24 defines a “forwardly tapered” shaft tip 24T.

As seen most clearly in, for example, FIGS. 1, 3 and 4A-4C, a drive-shaft proximal portion 26 extends lengthwise and forwardly of the proximal end 22 toward the distal end 24, while a drive-shaft distal portion 28 extends lengthwise and rearwardly of the distal end 24. A shaft intermediate portion 20_{IP} along the length of the drive shaft 20 is retained within the sleeve through-channel 42 such that the drive shaft 20 is axially rotatable relative to the shaft-retaining sleeve 40. Although the intermediate portion 20_{IP} can be regarded as a transition region—or including a transition region—between the proximal and distal portions 26 and 28, there is nothing fundamental to the understanding of the invention that requires conceptualizing the intermediate portion 20_{IP} in this way. In fact, since where the proximal portion 26 ends and the distal portion 28 begins in moving from the proximal end 22 to the distal end 24 may be somewhat arbitrary, the intermediate portion 20_{IP} could even be thought of as a sub-portion of either or both the proximal and distal portions 26 and 28. Additionally, while the particular means by which the intermediate portion 20_{IP} is retained within the shaft-retaining sleeve 40 is not of principal importance or relevance to the “precise point of novelty” of most embodiments, illustrative means achieving this mutual retention between drive shaft 20 and sleeve 40 are discussed later in the present description.

The second sub-assembly is a shaft receptacle 70 including a receptacle body 71. In various embodiments, including the illustrative versions of FIGS. 1, 2 and 3, the shaft receptacle 70 is configured as a mechanical fitting with receptacle front and rear ends 72 and 74. A cylindrical receptacle-interior wall 80 defines a cylindrical through-bore 82 and a through-bore axis A_{TB} about which the receptacle-interior wall 80 extends “coaxially about” between and through the receptacle front and rear ends 72 and 74. In addition to the receptacle-interior wall 80, the receptacle body 71 defines a receptacle-exterior side surface 84 that extends along the through-bore axis A_{TB} between the receptacle front and rear ends 72 and 74. Although the overall configuration of the receptacle-exterior side surface 84 may be generally cylindrical and coaxial with the receptacle-interior wall 80 about the through-bore axis A_{TB}, alternative configurations for the receptacle-exterior side surface 84 are certainly within the scope and contemplation of the inventive concept. In the examples shown, the receptacle-exterior side surface 84 is predominantly cylindrical, but is “keyed” by the inclusion of first and second “flats” 85A and 85B. As discussed in more detail later in the description, “keying” the receptacle-exterior side surface 84 by including, for example, at least one flat 85A or 85B prevents the rotation of the receptacle body 71 within an aperture (described later) into which it is fitted. Of course, “keying” by the inclusion of a shape that is other than a “flat,” but which still results in the receptacle-exterior side surface 84 deviating from completely cylindrical, will contribute to the same rotation-prevention objective.

The shaft receptacle 70 and drive shaft 20 are configured for selective mating receipt, engagement and retention of the drive-shaft distal portion 28 within the through-bore 82 of the shaft receptacle 70 as follows. Disposed peripherally about, and axially along, the drive-shaft distal portion 28 is at least a first helical groove 30, with at least some embodiments additionally including a second helical groove 32. Protruding radially inward from the receptacle-interior wall 80 toward the through-bore axis A_{TB} is at least a first drive pin 86A, the further inclusion of a second drive pin 86B being optional in some embodiments. For explanatory purposes, considered first and principally is an illustrative fastener assembly 5 in which the drive-shaft distal portion 28 incorporates only a single, first helical groove 30 and the receptacle-interior wall 80 has protruding radially inwardly therefrom only a first drive pin 86A.

As the shaft distal end 24 is axially introduced into the cylindrical through-bore 82, the drive shaft 20 is rotationally oriented (i.e., about the shaft axis A_{S}) such that the first drive pin 86A is aligned for entry into the first helical groove 30 through a first-groove entrance 30E located proximate the shaft distal end 24. With the first drive pin 86A mechanically registered with the first helical groove 26, the drive shaft 20 can be further advanced into, and partially though, the cylindrical through-bore 82 by rotating the drive shaft 20 about the shaft axis A_{S} in a rotational first direction RD₁ (e.g., clockwise or counterclockwise as viewed, for example, into the shaft proximal end 22). Correlatively, rotating the drive shaft 20 about the shaft axis A_{S} in a rotational second direction RD₂ opposite that of the rotational first direction RD₁ will result in lineal displacement of the drive shaft 20 out of the through-bore 82 of the shaft receptacle 70.

In embodiments in which the receptacle-interior wall 80 has further protruding radially inward therefrom a second drive pin 86B, the drive shaft 20 must include a second helical groove 32 for receipt of, and mechanical registration with, the second drive pin 86B. Furthermore, it will be appreciated that, where first and second drive pins 86A and 86B are included, they are mutually diametrically opposed within the cylindrical through-bore 82 as shown, for example, in FIG. 1. While the inclusion of first and second drive pins 86A and 86B requires the inclusion of first and second helical grooves 30 and 32, it will be readily appreciated that the inclusion of first and second helical grooves 30 and 32 does not require the inclusion of first and second drive pins 86A and 86B, as either of first and second helical grooves 30 and 32 could register with only a single, first pin 86A, for example.

The lineal displacement (i.e., axially along the aligned shaft and through-bore axes A_{S} and A_{TB}) of the drive shaft 20 as a function of angular (rotational) displacement of the drive shaft 20 about shaft axis A_{S} is determined by the pitch of the at least one first helical groove 30 defined on the drive shaft 20. As the pitch increases, the lineal displacement of the drive shaft 20 increases as a function of rotational displacement, but a greater force (torque) is required to rotate the drive shaft 20. Conversely, a lesser pitch, while requiring greater angular displacement (rotation) for a give lineal displacement, requires less torque to rotate the drive shaft 20.

In order to facilitate the application to the drive shaft 20 of torque sufficient in magnitude to helically advance the drive shaft 20 into the through-bore 82 of the shaft receptacle 70, the drive-shaft proximal portion 26 carries a knob 50. The knob 50 is attached to the drive-shaft proximal portion 26 such that both the knob 50 and the drive shaft 50 are rotatable in unison relative to the shaft-retaining sleeve 40; the knob 50 should be affixed to the drive-shaft proximal portion 26 such that the knob 50 and drive shaft 20 cannot rotate with respect to one another.

With principal reference to FIGS. 1, 3, 5A and 5B, in each of various illustrative versions, the knob 50 extends between knob rear and front ends 52 and 54. Extending from the knob front end 54 toward the knob rear end 52 is an interior sleeve-seating channel 58 configured for receipt and seating of at least a portion of the axial extent of the shaft-retaining sleeve 40. Farther to the rear (i.e., more toward the knob rear end) of the sleeve-seating channel 58 is a proximal-end socket 62. The proximal-end socket 62 is configured for receiving and retaining the shaft proximal end 22, as well as a portion of the drive-shaft proximal portion 26. In order to prevent relative rotation between the knob 50 and the drive shaft 20, the drive-shaft proximal portion 26 may be “keyed,” with the proximal-end socket 62 being keyed in a manner complementary to the manner in which the drive-shaft proximal portion 26 is keyed. For purposes of non-limiting illustration, the drive-shaft proximal portion 26 is depicted in various drawings as including at least one proximal-portion flat 26_{F}, while the proximal-end socket 62 is depicted with at least one corresponding socket flat 62_{F}. The knob 50 may be secured to the drive-shaft proximal portion 26 by any of various means, illustrating examples including the use of at least one of an adhesive such as epoxy, spot welding, and press fitting. Press fitting is the preferred method of various embodiments.

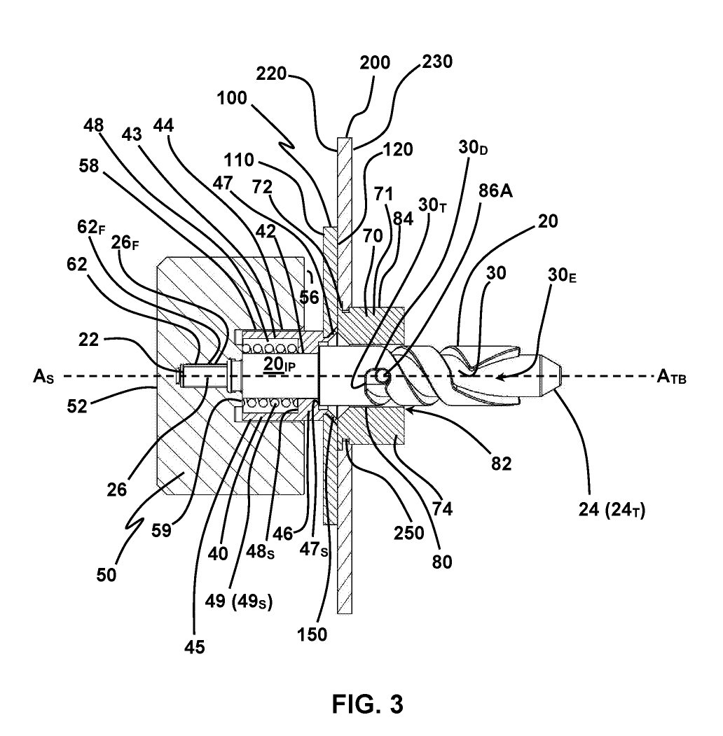

With principal reference to FIGS. 2 and 3, discussion is now provided as to how the first sub-assembly 10 is held captive to a removable module and how the second sub-assembly 70 (also referred to as shaft receptacle 70) is held secured to a chassis configured for receiving and supporting the removable module. An illustrative environment for implementation having been provided in the background and the summary—and with partial reference to the '655 patent—it is sufficient for current explanatory purposes to indicate that the removable module includes a module-mounting plate 100 and the chassis to which the module is to be mounted includes a module-support plate 200. Moreover, the module-mounting plate 100 has opposed mounting-plate front and back surfaces 110 and 120, while the module-support plate has opposed support-plate forward and rear surfaces 220 and 230. In mounting the module within the chassis, the objective is to “flush-mate” the mounting-plate back surface 120 in contacting engagement with the support-plate forward surface 220.

Defined through and between the mounting-plate front and back surfaces 110 and 120 is a retaining-sleeve aperture 150. Correspondingly, defined through and between the support-plate forward and rear surfaces 220 and 230 is a receptacle aperture 250. The shaft-retaining sleeve 40 is configured as a mechanical fitting that is “press fit” directly into a retaining-sleeve aperture 150 defined through the module-mounting plate 100. Likewise, the shaft receptacle 70 is press fit into the receptacle aperture 250 in defined through the module-support plate 200.

As shown in FIGS. 1 and 3, the cylindrical shaft-retaining sleeve 40 has sleeve-interior and sleeve-exterior surfaces 43 and 44 extending between sleeve proximal and distal ends 45 and 46. The sleeve-interior surface 43 defines the sleeve through-channel 42. At the sleeve distal end 46 there is defined a skirt 47, which is essentially a region along a short length of the sleeve-exterior surface 44 of reduced diameter. The “step down” of the outside diameter to the skirt 47 defines a skirt shoulder 47_{S}.

As seen in the cross-sectional view of FIG. 3, the shaft-retaining sleeve 40 is press fit to the module-mounting plate 100 from the mounting-plate front surface 110 by inserting the skirt 47 into the retaining-sleeve aperture 150. Preferably, the axial extent of the skirt 47 is predetermined so that, when the skirt 47 is deformed by the press fit operation, no portion of the skirt 47 extends through the aperture beyond the mounting-plate back surface 120; protrusion of the skirt 47 beyond the mounting-plate back surface 120 might interfere with flush contact between the mounting-plate back surface 120 and the support-plate forward surface 220. The extent to which the shaft-retaining sleeve 40 can be inserted into the retaining-sleeve aperture 150 is limited by the contacting engagement of the skirt shoulder 47_{S} shoulder with the mounting-plate front face 110. By the preceding explanation, it will be appreciated that a more general objective of various embodiments is that no portion of the first sub-assembly 10 extend beyond (i.e., protrude relative to) the mounting-plate back surface 120 other than the drive shaft 20.

In the particular version shown in FIG. 3, the retaining-sleeve aperture 150 is beveled so it tapers down in moving from the mounting-plate back surface 120 to the mounting-plate front surface 110. In other words, in this version, the area of the retaining-sleeve aperture 150 on the mounting-plate front surface 110 is less than it is on the mounting-plate back surface 120. In this way, the skirt 47—once press fit—flares outwardly to prevent its being pulled out from the front of the module-mounting plate 100 (i.e., from the side of the mounting-plate front surface 110). The press fit operation captures the module-mounting plate 100 between the skirt shoulder 47_{S} and the deformed (outwardly-flared) skirt 47. Normally, press fitting a cylindrical component into a circular aperture should be sufficient to prevent rotation of the component within the aperture. However, to ensure against rotation of the shaft-retaining sleeve 40 within the sleeve-retaining aperture 150, the aperture 150 and sleeve 40 could be “keyed” in a complementary fashion.

As shown most clearly in FIG. 3, and stated previously, the interior of the shaft-retaining sleeve 40 includes a sleeve through-channel 42, which is defined by the sleeve-interior surface 43. The sleeve-interior surface 43 is configured such that the sleeve through-channel 42 varies in diameter. More specifically, toward the sleeve distal end 46, the sleeve through-channel 42 has a reduced diameter just larger than the shaft intermediate portion 20IP so as to securely support the drive-shaft 20 for rotation within the shaft-retaining sleeve 40 as previously described.

More toward the sleeve proximal end 45 (closer to the shaft proximal end 22), the through-channel 42 has a larger diameter than the portion of the drive shaft 20 extending therethrough, thusly defining a sleeve void 48 annularly disposed about the shaft intermediate portion 20_{IP} to the inside of the sleeve-interior surface 43. The “step down” of the inside diameter of the though-channel 42 from the sleeve void 48 defines an annular void shoulder 48_{S} representing a forward or distal end of the sleeve void 48.

With continued reference to FIG. 3, within the sleeve void 48 there is disposed about the shaft intermediate portion 20_{IP} a biasing member 49 in the form of a coil spring 49_{S}. The coil spring 49_{S} is disposed so as to normally bias the drive shaft 20 in a rearward axial direction. In the illustrative version depicted, the coil spring 49_{S} undergoes compression between the void shoulder 48_{S} against which one end of the coil spring 49_{S} bears and an annular spring-bearing surface 59 within the knob 50 against which the other end of the coil spring bears 49_{S}. While the two ends of the coil spring 49_{S} are not referenced by number, it is readily apparent that the coil spring 49_{S} inherently includes two ends. In the illustrative case depicted, the spring-bearing surface 59 corresponds to a step-down in diameter between sleeve-seating channel 58 and the proximal-end socket 62.

It can be appreciated from the preceding that encapsulated within the knob 50 is a majority of the axial extent of the shaft-retaining sleeve 40 and, within the shaft-retaining sleeve 40, the biasing member 49. In fact, thusly configured, the only portion of the first sub-assembly 10 that protrudes through the sleeve-retaining aperture 150 from the mounting-plate front surface 110 and behind the mounting-plate back surface 120 is the drive-shaft distal portion 28. This arrangement minimizes the number of hardware components, efficiently “packages” them on the user side of the module-mounting plate 100, and facilitates a flush, contacting engagement of the mounting-plate back surface 120 with the support-plate forward surface 220.

Further contributing to a flush, contacting engagement between the mounting-plate back surface 120 and the support-plate forward surface 220 is the press fitting of the shaft receptacle 70 into the receptacle aperture 250 such that little or none of the shaft receptacle 70 extends beyond the plane (i.e., protrudes relative to) of the support-plate forward surface 220. The particular manner in which this is achieved, and by what configurations, is of quite secondary importance. One illustrative non-limiting way of achieving this preferred result can be readily gleaned by a person of ordinary skill in various related arts FIGS. 2 and 3.

With the shaft-retaining sleeve 40 held captive by the module-mounting plate 100, the shaft receptacle 70 held captive by the module-support plate 200, and at least a first drive pin 86A and a first helical groove 30 mutually mechanically registered, the module-mounting plate 100 drawn toward the module-support plate 200, by rotating the drive shaft 20 in the rotational first direction RD₁. As the drive shaft 20 advances into the through-bore 42, the first drive pin 86A advances within the first helical groove 30 from the first-groove entrance 30E toward the shaft proximal end 22. The maximum extent to which the first drive pin 86A can advance into the first helical groove 30 is defined by a first-groove terminus 30_{T}. Correlatively, rotating the drive shaft 20 about the shaft axis A_{S} in the rotational second direction RD₂ opposite that of the rotational first direction RD₁ results in lineal separation of the module-mounting and module-support plates 100 and 200.

In various embodiments, such as those depicted in the various drawings, the—first-groove terminus defines a detent 30D which, when entered by the first drive pin 86A, permits the drive shaft 20 to displace axially between the aforementioned forwardmost and rearwardmost axial shaft positions relative to the shaft-retaining sleeve 40. As previously explained, the drive shaft 20 is normally biased toward the rearwardmost axial shaft position by a biasing member 49. Moreover, the detent 30D is configured such that, as the first drive pin 86A approaches the first-groove terminus 30T, the biasing member “loads” (e.g., compresses) by forcing limited forward axial displacement of the drive shaft 20 and then, as the drive pin “falls into” to the detent 30D, the biasing member 49 “unloads” or “releases” potential energy stored during compression. This action creates a tactile sensation perceptible to the operator (e.g., a slight jolt and a “click” sound). Rotation of drive shaft 20 in the opposite, rotational second direction RD₂ overcomes the force exerted by the biasing member 49, thus causing first drive pin 86A to exit the detent 30D and travel along the first helical groove 30 forward toward the shaft distal end 24.

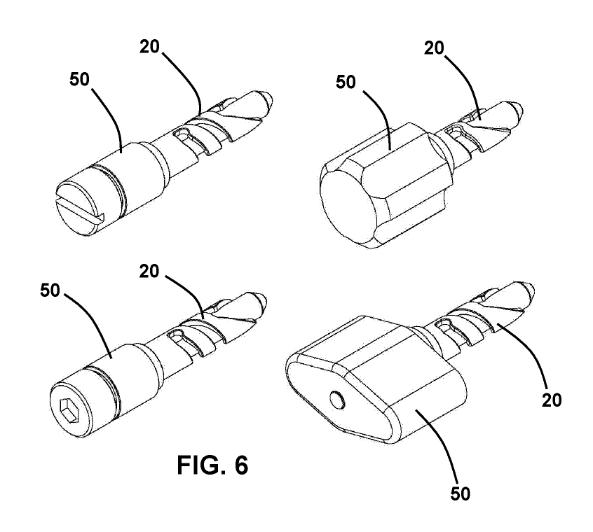

It is to be understood that the configuration of the knob 50 is immaterial to the realization of the advantages of the provided by the inventive concept. FIG. 6 is provided merely to illustrative and suggest various illustrative knob configurations that might be conducive to disparate applications. Moreover, the knob 50 can be formed from various materials, two of the more common being metal and plastic. The illustrative knob of FIG. 5A is unitary structure formed from a single material such as metal or plastic. The illustrative knob of FIG. 5B is predominantly formed of plastic, but further includes a metal insert 51 defining at least one of a proximal-end socket 62 for receiving a shaft proximal end 22 and a spring-bearing surface 59.

The foregoing is considered to be illustrative of the principles of the invention. Furthermore, since modifications and changes to various aspects and implementations will occur to those skilled in the art without departing from the scope and spirit of the invention, it is to be understood that the foregoing does not limit the invention as expressed in the appended claims to the exact constructions, implementations and is versions shown and described.

What is claimed is:

1. A hand-operated helix-drive captive-panel fastener assembly configured for selectively retaining a module-mounting plate of a module to be mounted within a module chassis flush against a module-supporting plate carried by the module chassis, the fastener assembly comprising:
a first sub-assembly including
(a) a drive shaft extending lengthwise between a shaft proximal end and a shaft distal end and having a drive-shaft proximal portion extending lengthwise and forwardly of the proximal end toward the distal end, a drive-shaft distal portion extending lengthwise and rearwardly of the distal end toward the proximal end, and a shaft intermediate portion situated along the lengthwise extent of the drive shaft such that at least a portion of the drive-shaft proximal portion extends rearwardly of the intermediate portion and at least a portion of the drive-shaft distal portion extends forwardly of the intermediate portion, there being defined peripherally about and axially along the distal portion a helical groove, and
(b) a cylindrical shaft-retaining sleeve having defined therethrough a through-channel through which the drive shaft extends and within which the shaft intermediate portion is retained for rotation, while being restrained for limited axial displacement, relative to the shaft-retaining sleeve; and
a second sub-assembly including
(c) a shaft receptacle having a cylindrical receptacle-interior wall defining a cylindrical through-bore and a through-bore axis about which the receptacle-interior wall extends, and
(d) a drive pin protruding inwardly from the receptacle-interior wall toward the through-bore axis; wherein
(i) the shaft receptacle and drive shaft are configured for selective mating engagement by the axial introduction and angular alignment of the shaft distal end into the through-bore of the shaft receptacle such that the drive pin enters the helical grove and, with the drive pin and helical groove mechanically registered, further advancing the drive shaft into the through-bore by rotating the drive shaft in a rotational first direction;
(ii) the module-supporting plate carried by the module chassis has defined therethrough a receptacle aperture within which the shaft receptacle is held captive against both axial and lineal displacement relative to the module-supporting plate;
(iii) the module-mounting plate of the module has defined therethrough a retaining-sleeve aperture within which the shaft-retaining sleeve is held captive against both rotation and axial displacement relative to the module-mounting plate; and
(iv) with the drive pin mechanically registered with the helical groove, the module-mounting plate can be advanced toward and into flush contacting engagement with the module-support plate by rotation of the drive shaft in the rotational first direction, and, by rotation of the drive shaft in a rotational second direction opposite that of the rotational first direction, the module-mounting and module-supporting plates can be separated from contacting engagement, and the module freed from the module chassis.

2. The fastener assembly of claim 1 wherein at least one of
(i) the shaft receptacle is held directly captive within the receptacle aperture of the module-supporting plate by a press fit; and
(ii) the shaft-retaining sleeve is held directly captive within the retaining-sleeve aperture of the module-mounting plate by a press fit.

3. The fastener assembly of claim 2 wherein the draft-shaft proximal portion carries a knob.

4. The fastener assembly of claim 3 wherein the drive shaft is axially restrained for limited axial displacement between forwardmost and rearwardmost axial shaft positions relative to the shaft-retaining sleeve, and normally biased toward the rearwardmost axial shaft position by a biasing member.

5. The fastener assembly of claim 4 wherein the drive pin enters the helical groove through a groove entrance and, as the drive shaft is rotated in the rotational first direction, advances toward a groove terminus, the arrival of the drive pin at the groove terminus corresponding to flush contacting engagement of the module-mounting plate with the module-support plate.

6. The fastener assembly of claim 5 wherein the groove terminus defines a detent which, when entered into by the drive pin, permits the drive shaft to displace axially between the forwardmost and rearwardmost axial shaft positions, the detent being configured such that, as the drive pin approaches the groove terminus, the biasing member is caused to store energy under compression as a result of forced limited forward axial displacement of the drive shaft and then, as the drive pin enters the detent, the biasing member releases energy, thereby biasing the drive shaft toward its rearwardmost axial position, the release of energy and rearward displacement of the drive shaft creating a tactile sensation perceptible to the operator.

7. A hand-operated fastener assembly configured for mounting a module to a module chassis, the fastener assembly comprising:
a module-mounting plate depending from the module and having defined therethough a retaining-sleeve aperture;
a module-support plate depending from the module chassis and having defined therethough a receptacle aperture;
a first sub-assembly including a shaft-retaining sleeve defining a through-channel through which there extends, and within which there is retained, a drive shaft having drive-shaft proximal and distal portions, the drive shaft being retained within the through-channel for rotation relative to the shaft-retaining sleeve and having defined along the drive-shaft distal portion a helical groove, the shaft-retaining sleeve being press fit within the retaining-sleeve aperture defined through the module-mounting plate such that the drive-shaft proximal and distal portions protrude from opposite sides of the module-mounting plate; and
a shaft receptacle defining a cylindrical through-bore and having a drive pin protruding into the through-bore and configured for selective mechanical registration with the helical groove, the shaft receptacle being press fit within the receptacle aperture defined through the module-supporting plate; wherein
with the drive pin mechanically registered with the helical groove, the module-mounting plate can be advanced toward and into flush contacting engagement with the module-support plate by rotation of the drive shaft in the rotational first direction, and, by rotation of the drive shaft in a rotational second direction opposite that of the rotational first direction, the module-mounting and module-supporting plates can be separated from contacting engagement.

8. The fastener assembly of claim 7 wherein the draft-shaft proximal portion carries a knob.

9. The fastener assembly of claim 7 wherein the drive shaft is axially restrained for limited axial displacement between forwardmost and rearwardmost axial shaft positions relative to the shaft-retaining sleeve, and normally biased toward the rearwardmost axial shaft position by a biasing member.

10. The fastener assembly of claim 9 wherein the drive pin enters the helical groove through a groove entrance and, as the drive shaft is rotated in the rotational first direction, advances toward a groove terminus, the arrival of the drive pin at the groove terminus corresponding to flush contacting engagement of the module-mounting plate with the module-support plate.

11. The fastener assembly of claim 10 wherein the groove terminus defines a detent which, when entered into by the drive pin, permits the drive shaft to displace axially between the forwardmost and rearwardmost axial shaft positions, the detent being configured such that, as the drive pin approaches the groove terminus, the biasing member is caused to store energy under compression as a result of forced limited forward axial displacement of the drive shaft and then, as the drive pin enters the detent, the biasing member releases energy, thereby biasing the drive shaft toward its rearwardmost axial position, the release of energy and rearward displacement of the drive shaft creating a tactile sensation perceptible to the operator.

12. The fastener assembly of claim 11 wherein the biasing member is a coil spring helically disposed about the drive shaft, and at least partially internal to the shaft-retaining sleeve within a sleeve void with a void shoulder against which one end of the coil spring bears.

13. The fastener assembly of claim 12 wherein the drive-shaft proximal portion carries a knob and the coil spring undergoes compression between the void shoulder, against which one end of the coil spring bears, and an annular spring-bearing surface within the knob, against which the other end of the coil spring bears.

14. The fastener assembly of claim 7 wherein the module-mounting plate includes mutually opposed mounting-plate front and back surface, the module-support plate includes mutually opposed support-plate forward and rear surfaces, and, when the module-mounting and module-support plates are drawn into contacting engagement, the mounting-plate back surface is in contact with the support-plate forward surface.

15. The fastener assembly of claim 14 wherein no portion of the first sub-assembly other than the drive shaft protrudes relative to the mounting-plate back surface.

16. The fastener assembly of claim 15 wherein no portion of the shaft receptacle protrudes relative to the support-plate forward surface.
